(19) United States
(12) Patent Application Publication
(10) Pub. No.: US 2015/0234064 A1
(43) Pub. Date: Aug. 20, 2015

(54) VIBRATION ISOLATION SECTION

(71) Applicant: PHOENIX ENGINEERING SYSTEMS PTY LTD, Sydney, New South Wales (AU)

(72) Inventors: Donald Innes Wallace, Sydney (AU); Paul Lee, Sydney (AU)

(73) Assignee: PHOENIX ENGINEERING SYSTEMS PTY LTD, Sydney, New South Wales (AU)

(21) Appl. No.: 14/425,268

(22) PCT Filed: Sep. 4, 2013
(86) PCT No.: PCT/AU2013/000992

§ 371 Date: Mar. 2, 2015

(30) Foreign Application Priority Data
Sep. 6, 2012 (AU) 2012903871

(51) Int. Cl. G01V 1/20; G01V 1/38

(52) U.S. Cl. CPC G01V 1/201; G01V 1/38; G01V 2001/205

(57) ABSTRACT

A vibration isolation section (20) for use in a seismic streamer system, the section (20) including: a resilient sheath (30) arranged to be connected end-to-end in a seismic streamer (16) system and receive axial loads transmitted through the system, wherein the resilient sheath (30) is configured to stretch upon receiving an axial load and substantially convert the axial load into a radial stress; and a first support structure (42) housed within a first portion (31) of the resilient sheath(30), the first support structure (42) including one or more members having substantially constant diameter under load which provides a reaction to the radial stress, thereby reacting to the received axial load; and a second support structure housed at least in part within a second portion (33) of the resilient sheath(30), the second support structure including an enclosed fixed volume fluid filled flexible chamber (46) at least partially housed within the second portion (33) of the resilient sheath (30), the fluid filled flexible chamber (46) providing a reaction to the radial stress thereby reacting to the received axial load.

### FIELD OF THE INVENTION

The present invention relates generally to the field of marine seismic survey apparatus. More particularly, the invention relates to vibration isolation sections, otherwise known as stretch sections, used in marine seismic streamer systems to reduce noise.

### PRIOR ART

It is to be noted that a reference to prior art herein is not an admission that the prior art is common general knowledge to a person skilled in the art or any other person in any sense whatsoever.

Marine seismic survey apparatus typically include arrays of seismic sensors disposed in a structure that is towed by a seismic vessel through a body of water, such as a lake or the ocean. Such seismic receiver structures are commonly known as streamers.

Streamers are typically made in segments of about 75, 100 or 150 m in length. A streamer may include 100 or more such segments coupled end-to-end to form the complete streamer. Each streamer segment generally includes one or more high strength members that extend the length of the streamer segment. The streamer is generally constructed to allow for buoyancy trimming by means of adding buoyancy or ballast in order to achieve neutral buoyancy in the towing environment. Electrical and/or optical acoustic sensors are disposed along the length of the streamer at spaced apart locations. Electrical and/or optical cables extend along the length of the streamer and are coupled to the sensors so as to transmit signals generated by the sensors in response to sound energy to a recording device, which may be on the seismic vessel or at another location. Other conductors may be used to transmit electrical power. The streamer segment typically includes a combination of mechanical and electrical/optical coupling at each of its axial ends so that the streamer segment can be coupled to another such streamer segment, telemetry module or, through a stretch section, to a lead in cable, explained further below, coupled to the seismic vessel. The mechanical aspect of the coupling transfers axial force from segment to segment and ultimately to the seismic vessel through the lead in cable.

In a typical seismic survey acquisition system, one or more streamers made as described above are towed behind the seismic vessel in the water. In acquisition systems having more than one streamer, the streamers are typically laterally separated from each other by coupling their forward ends at spaced apart positions to a spreader cable that extends transversely to the direction of motion of the seismic vessel. The spacing is maintained by placing the spreader cable under tension by the use of diverters or paravanes that generate a transverse force by virtue of being towed through the water. These devices are simply aerofoils generating lift in the transverse direction.

The lead in cable includes a plurality of electrical and/or optical conductors that are essentially completely surrounded by one or more layers of helically wound steel wires. The steel wires are referred to as armour and protect the conductors from damage, and transmit axial load between the vessel and the streamers.

A particular issue that concerns marine seismic survey acquisition systems is a type of noise created by movement of the water past the lead in cable and the spreader cable. The noise is sometimes known as strumming and such noise can be of a nature so as to materially adversely affect the quality of the seismic signals detected by the sensors in the streamers. Other types of noise that affect the streamers include mechanically generated noise in the diverters and fluctuations in the towing speed caused by variations in water conditions. One device known in the art for reducing transmission of such noise between the lead in cable and the streamer is known as a vibration isolation section or stretch section.

A stretch section can be formed similar to a streamer segment, as described above, with the principal differences being that the strength member in the stretch section is typically formed from a more elastic material than that used for streamer segments. Lengths would typically be in the order of 50 m to 100 m. Existing designs of this type have the advantage that they can be reeled onto a seismic drum and offer high back deck operational efficiency during streamer deployment and retrieval. However, they have several significant disadvantages which are that their length leads to longer offsets for the streamer relative to the source, they are easily damaged and are filled with an oil-based fluid which presents environmental and safety issues. These products tend to have good attenuation at frequencies lower than around 8 Hz due to the low overall stiffness afforded by the long length. The product has a low loss tangent but achieves good attenuation at frequencies higher than about 12 Hz due to accumulation of loss over the long length.

Another type of device for reducing such noise transmission is configured as a solid, elastomer cylinder of a selected length typically between 1 m and 10 m. These devices tend to offer the advantage of being very short, leading to low streamer offsets but tend to be of a significantly larger diameter. Such products tend to be very heavy and, due to their large diameter, cannot be handled by the normal streamer handling and storage equipment fitted in seismic vessels and need to be manually added into the streamer on deployment and removed out of the streamer on recovery. This presents significant operational efficiency problems as well as health and safety problems to the seismic operators. These products tend to have good attenuation at frequencies in the 3 Hz to 8 Hz range due to the low axial stiffness but offer very little attenuation at frequencies less than 3 Hz. The product generally has poorer attenuation at frequencies higher than about 12 Hz due to a relatively low loss tangent and very short length.

Another type of device in use is known as the radial stretch. This device consists of a cross-ply hose type construction enclosing a fixed volume of liquid, which is typically oil based, and having a typical length of 10 to 20 m. In this product, axial strain of the stretch is converted into radial strain in the hose by virtue of the hose containing constant internal volume of liquid. This construction allows for a low axial stiffness in a relatively small diameter and has a higher loss tangent than the other section types due to hose material choice and the cross ply construction. One of the key parameters in determination of the stiffness is the helical angle of the cross ply construction whereby larger helical wrap angles lead to lower axial stiffness. In the constant volume model, the highest angle achievable is in the region of 52 degrees and this represents a limit to the design. Fibres arranged at angles between 52 degrees and 90 degrees go into compression when the stretch is subjected to axial strain and therefore do not contribute to the stiffness at those angles. This product offers the advantage of being able to be handled by existing streamer recovery, deployment and storage equipment and its attenuation performance at low and high frequencies is good as a result of being able to offer a low stiffness and a high loss tangent. However, it has been noted that this product is not effective at frequencies less than around 3 Hz.

Another type of stretch device is one constructed by attaching a number of stretch type members sometimes known as shock cords between two opposing plates. There may be up to between 10 or 15 stretch members fitted in parallel and lengths could be in the order of 1 m to 10 m. The plates tend to be of a fairly large diameter compared to other stretch products and similar or larger diameter than the elastomer cylinder type referred to above. The advantage of this kind of device is that it is fairly easy to adjust the stiffness properties by changing the length and or the number of shock cords fitted. The attenuation performance of the device in the 3 Hz to 10 Hz range can be very good due to the low stiffness achievable but performance at higher frequencies is typically poor due to the typically low loss tangent of the shock cords. However, it has been noted that the device does not offer useful attenuation in the sub-3 Hz range. Short lengths also lead to lower streamer offsets that are desirable. The key disadvantage is that such products cannot be handled easily by the normal streamer handling and storage equipment fitted in seismic vessels and need to be manually added into the streamer on deployment and removed out of the streamer on recovery. This presents significant operational efficiency problems as well as health and safety problems to the seismic operators.

It is an object of the invention to overcome some of the problems of the prior art or at least provide a useful alternative.

### SUMMARY OF THE INVENTION

According to the present invention there is provided a vibration isolation section for use in a seismic streamer system, the section including:
a resilient sheath arranged to be connected end-to-end in a seismic streamer system and receive axial loads transmitted through the system, wherein the resilient sheath is configured to stretch upon receiving an axial load and substantially convert the axial load into a radial stress; and
a first support structure for the resilient sheath and housed within a first portion of the resilient sheath and arranged to resist at least substantial radial contraction of the first portion of the sheath when the sheath is stretched, the support structure including one or more members having substantially constant diameter under load which provides a reaction to the radial stress, thereby reacting to the received axial load; and
a second support structure housed at least in part within a second portion of the resilient sheath, the second support structure including an enclosed fixed volume fluid filled flexible chamber at least partially housed within the second portion of the resilient sheath, the fluid filled flexible chamber providing a reaction to the radial stress thereby reacting to the received axial load.

Preferably the resilient sheath is an elastic sheath.

Preferably the first support structure has a coiled-spring structure of substantially constant diameter. Alternatively, the first support structure may be in the form of a plurality of spaced apart hoop-shaped members arranged along at least a portion of the length of the sheath.

Preferably the first support structure is integrally formed with the sheath.

In preferred embodiments, the sheath has a structure including one or more layers of helically wrapped fibres. Preferably, the layers are embedded in a resilient material where the resilient material preferably is a natural or a synthetic rubber material, or a polyurethane material.

Preferred embodiments provide the fibres in the first portion of the sheath are predominantly wrapped at an angle between 52° and 90° relative to a central axis of the sheath and fibres in the second portion of the sheath are predominantly wrapped at an angle of no more than 52° relative to the central axis of the sheath.

Advantageously higher fibre helical wrap angles reduce the stiffness of the resilient sheath when compared to lower helical wrap angles. A reduction in stiffness of the sheath and section communicates to a reduction in impedance of the section and an increase in attenuation of noise in the section.

The first support structure advantageously allows for fibre helical wrap angles higher than 52 degrees in the first portion of the sheath therefore a lower overall section stiffness is achievable by employing higher no load fibre helical wrap angles in the first portion of the sheath when compared to some if not all prior art sections.

Advantageously the change in fibre angle between the first and second portion of the sheath introduces a change in linear stiffness between the first and second portion and this introduces an impedance mismatch component within the sheath that would not otherwise exist if the fibre angle in the first and second portion of the sheath was the same. An impedance mismatch in the sheath advantageously contributes to attenuation of axial noise.

Additionally the first and second support structures corresponding to the first and second portions of the sheath introduce a change in density along the length of the section which amounts to an additional impedance mismatch occurring in the section which would not otherwise arise in sections having a uniform support structure for the entire section, and this additional impedance mismatch advantageously contributes to additional attenuation of axial noise.

Preferably the sheath at least in part defines the chamber and a first portion of the chamber is housed within the first portion of the resilient sheath and a second portion of the chamber is housed within the second portion of the resilient sheath.

Advantageously on the section and sheath receiving an axial load both the first and second portions of the sheath stretch however the volume of the first portion of the chamber cooperatively increases as the volume of the second portion of the chamber decreases as a volume of fluid moves between the second and first portions of the chamber.

Advantageously viscous friction arises when the fluid moves in reaction to the axial load absorbing energy from the moving fluid contributing to attenuation of noise.

Preferably the first portion of the chamber is in communication with the second portion of the chamber by at least one partitioning orifice.

Advantageously attenuation of noise for any given sized section can be tuned by means of cooperatively employing fluids of selective viscosity and or a selectively sized partitioning orifice.

Preferably the chamber includes a solid mass that is free to move at least partially within the chamber in reaction to the moving fluid.

Advantageously the moveable solid mass in the flexible fluid filled chamber within the resilient sheath acts like a spring mass system or dynamic absorber system and frictional losses occur when the solid mass moves in reaction to the moving fluid giving rise to a dynamic absorber effect and contributing to further attenuation of noise most prominently at the resonant frequency of the spring mass system or dynamic absorber system.

Advantageously selective choice of the solid mass for any given sized section can provide a means for tuning the resonant frequency of the dynamic absorber effect and increase attenuation of noise in the section at that resonant frequency.

Preferably the vibration isolation section includes a snubber member such as a rope for limiting the length that the sheath can be stretched.

Preferably the fluid is a gel.

According to another aspect of the present invention there is provided a seismic streamer system incorporating one or more embodiments of the vibration isolation section in accordance with the present invention.

Advantageously preferred embodiments of the invention allow for the construction of low impedance sections when compared to most if not all prior art radial stretch sections of the same size and these low impedance sections advantageously can communicate to reduced operational lengths of the section further communicating to reduced operational offsets which is desirable in seismic operations.

Additionally low impedance sections advantageously communicate to higher attenuation of noise particularly at low frequencies when compared to at least some if not all prior art radial stretch devices.

### DRAWINGS

Preferred embodiments of the present invention will now be described with reference to the accompanying drawings, in which:

FIG. 1 shows a marine seismic acquisition system in which a vibration isolation section according to the present invention can be used.

FIG. 2 shows a partial cross-sectional view of a vibration isolation section according to a first preferred embodiment of the present invention.

FIG. 3 shows a partial cross-sectional view of vibration isolation section according to a second preferred embodiment of the present invention.

FIGS. 4 to 6 show partial cross-sectional views of a vibration isolation section according to alternative preferred embodiments of the present invention.

### DETAILED DESCRIPTION OF EMBODIMENTS OF THE INVENTION

It is to be noted where possible features common to the various embodiments illustrated in the drawings are referred to in each drawing by a respective common feature number.

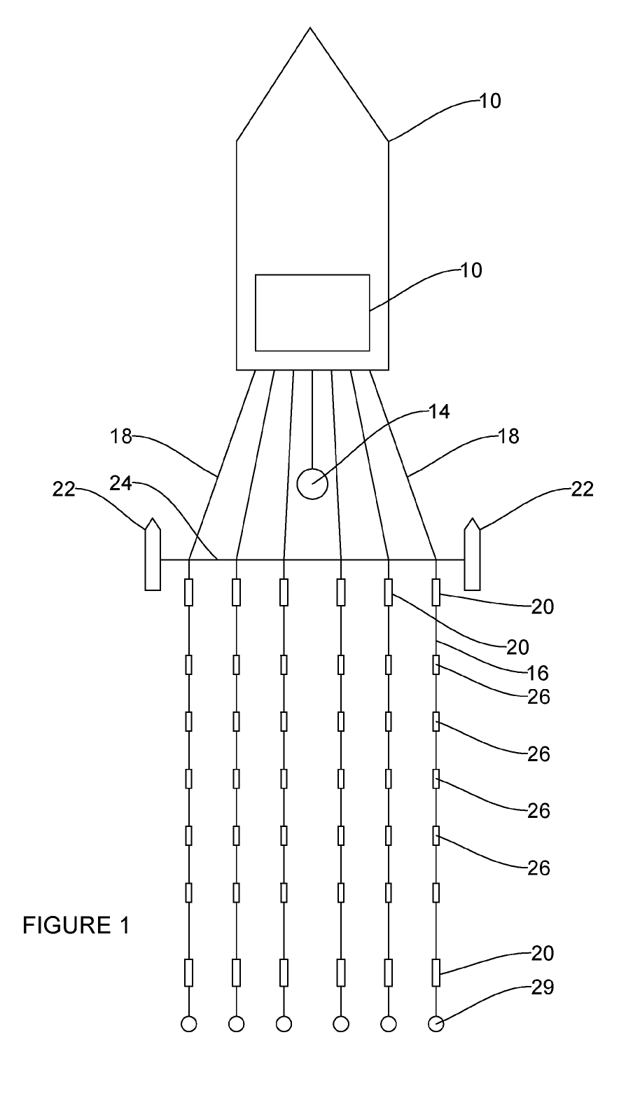

A marine seismic acquisition system is shown in FIG. 1. The seismic data acquisition system includes a seismic vessel 10 towing a plurality of laterally spaced apart seismic streamers 16 through a body of water such as a lake or the ocean. The seismic vessel 10 typically includes instrumentation thereon collectively called a recording system, shown generally at 12. The recording system 12 may include navigation devices, electrical power supplies, data recording equipment and seismic source actuation equipment of types well known in the art. The data recording equipment (not shown separately for clarity of the illustration) makes recordings, typically indexed with respect to time of actuation of a seismic energy source 14, of signals detected by seismic sensors 26 disposed at spaced apart locations along the streamers 16.

The streamers 16, as explained previously, can be made from a plurality of segments (not shown separately). A streamer may include many such segments coupled end-to-end to form the complete streamer 16. Each streamer segment may include one or more high strength members (not shown) that extend the length of the streamer segment. Electrical and/or optical sensors 26 are disposed along the length of the strength member at spaced apart locations. Electrical and/or optical conductors (not shown) in a cable extend along the length of the streamer 16 and are coupled to the sensors 26 so as to transmit signals to the recording system 12 that are generated by the sensors 26 in response to seismic energy. The streamer segments may include a combination of mechanical and electrical/optical coupling (not shown) at each of their axial ends so that the streamer segments can each be coupled to another such streamer segment, telemetry module or to a lead in cable 18.

There is shown one lead in cable 18 for each of the streamers 16 to couple each of the streamers 16 mechanically, and electrically and/or optically to the seismic vessel 10. Mechanical coupling enables the vessel 10 to pull the streamers 16 through the water. Electrical and/or optical coupling enables signals from the sensors 26 to be carried to the recording system 12. The lead in cable 18 may include electrical and/or optical conductors (not shown) surrounded by helically wound steel armour wires. The conductors carry the signals and/or carry electrical power. The armour wires transmit axial force from the vessel 10 for towing, and protect the conductors from damage.

In the seismic acquisition system shown in FIG. 1, the streamers 16 are towed at laterally spaced apart positions with respect to each other. Lateral separation is maintained between the streamers 16 by coupling the lead in end of each streamer 16 to a spreader cable 24. The spreader cable 24 extends generally transversely to the direction of motion of the seismic vessel 10, and includes at each of its ends a diverter 22. The diverters 22 act co-operatively with motion of the water as the seismic acquisition system is towed through the water such that tension is maintained on the spreader cable 24.

The seismic energy source 14 can be of any type known in the art for marine seismic data acquisition. FIG. 1 shows the source 14 being towed by the seismic vessel 10. Alternative arrangements may include a plurality of such seismic energy sources, or may have one or more seismic energy sources towed by a different vessel.

As shown in FIG. 1, each streamer 16 includes a tail buoy 29 at the end most distant from the seismic vessel 10. The tail buoys 29 may include navigation and/or signal telemetry devices known in the art, such as a global positioning system (GPS) receiver and wireless data telemetry transceiver.

All of the foregoing components of a marine seismic data acquisition system may be of types well known in the art. Particular specifications for any of the foregoing components of a marine seismic data acquisition system are a matter of discretion for the designer and user of such systems, and are therefore not limitations on the scope of the invention.

In FIG. 1, each streamer 16 is coupled to its respective lead in cable 18 using a vibration isolation section 20. The streamers 16 may also be coupled to their respective tail buoys 29 using a similar vibration isolation section 20. The vibration isolation sections 20 provide a resilient and preferably elastic coupling between the respective streamers 16 and lead in cables 18, and if used between the streamer 16 and the respective tail buoys 29, such that vibrations coming into the streamer 16 from the head end or the tail end are substantially attenuated.

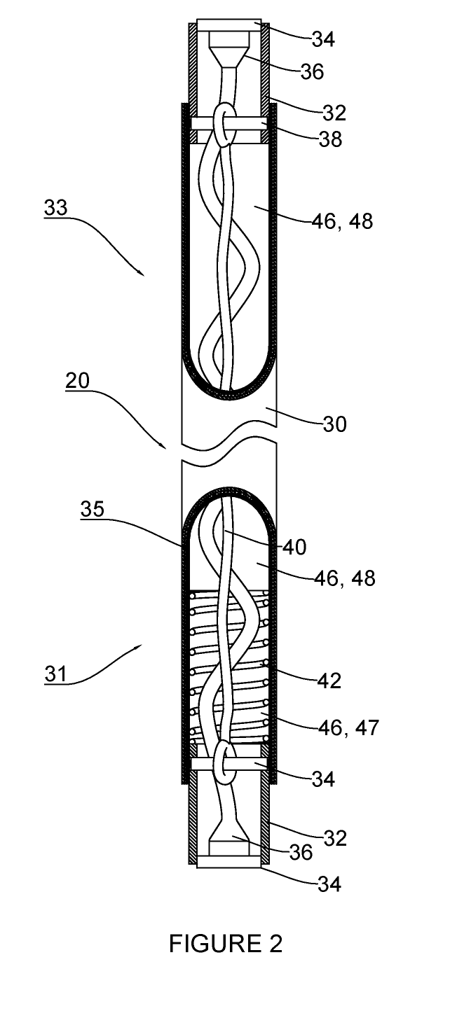

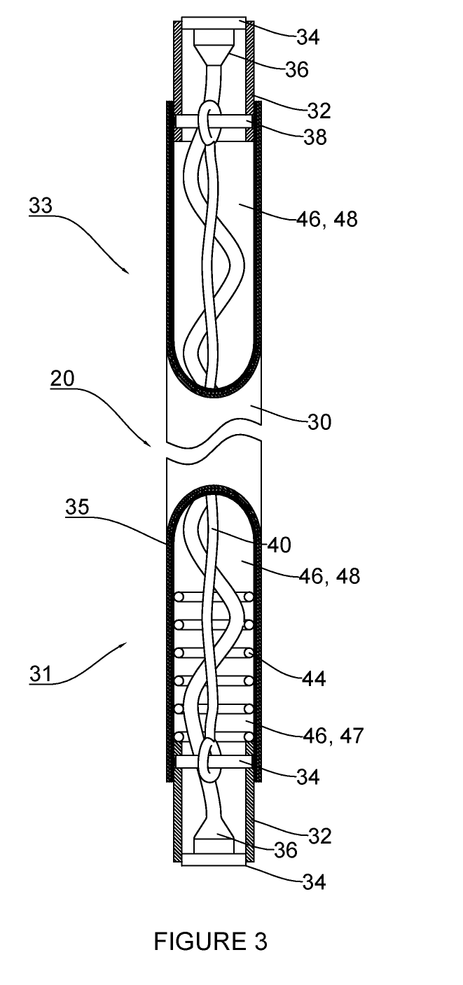

Alternative embodiments of the vibration isolation section 20 are shown in FIGS. 2 and 3.

The section 20 includes a hose-like elastic sheath 30. The elastic sheath 30 has a cross-ply construction using a number of layers of helically wrapped fibres embedded in a matrix of a rubber material. The fibres may be of a high strength fibre but can be a polyester material. The matrix may be of a rubber-type material, such as a natural rubber or synthetic rubber material, e.g neoprene. The rubber-type material may ideally have a high loss tangent. The wrap angle of the fibres at zero axial load in a first portion 31 of sheath 30 may ideally be higher than 52 degrees relative to central axis, and in a second portion 33 of sheath 30 may ideally be no higher than 52 degrees relative to central axis.

Advantageously the change in the no load wrap angle of the fibres between the first and second portion 31, 33 of the sheath 30 effectively gives rise to a change of stiffness of the sheath 30 between the first and second portion 31, 33 and this introduces an impedance mismatch in section 20 that would not otherwise exist if the no load wrap angle of the fibres between the first and second portion 31, 33 were the same. Advantageously this additional impedance mismatch in section 20 contributes to the attenuation of noise in section 20.

When the elastic sheath 30 receives axial loads transmitted through the streamer system, to which it is connected, the elastic sheath 30 is caused to stretch. The construction of the sheath 30 is such as to provide a radial stress upon stretching. In other words, the received axial load is substantially converted into a radial stress.

The sheath 30 at each end is attached to a connector housing 32, for example by means of a bonding technique such as vulcanisation or by swaging or crimping or some combination of those techniques. The connector housing 32 is constructed such that it is able to transmit the mechanical force between the section 20 and the attached components. The connector housing 32 may be manufactured from a high strength material, such as titanium.

An electrical or electrical/optical connector insert 34 is mounted inside each connector housing 32 at each end of the section 20 and is of a configuration suited to the wiring scheme of the streamer that the section is intended to be fitted to.

Connector inserts 34 are fitted to each end of an electrical or electrical/optical harness 36 which is of a construction such that it is subjected to very small strains when the stretch is fully extended. The construction can be in the form of helical coil.

As shown, a pin 38 is fitted into each connector housing 32 and a snubber rope 40 is anchored to each pin 38 such that snubber rope 40 extends between the two pins 38. The pin 38 transmits force between the connector housing 32 and the snubber rope 40 in the event that the stretch is extended to a snubbing length.

The snubber rope 40 is of a length such that it takes up axial load when the sheath 30 is extended to its snubbing length. Any further force is taken up by the snubber rope 40 instead of the sheath 30, and further extension is limited by the stiffness of the snubber rope 40. The snubber rope 40 is of a high strength construction such as Kevlar and designed to fail at a load significantly higher than the snubbing load. This prevents damage to the sheath 30 under excessive loads.

The first portion 31 of sheath 30 is radially supported by a support structure 42, 44 that reacts against the radial stress in the sheath 30 when it is extended axially. The support structure 42, 44 maintains a near constant diameter under load within the operating range of the stretch. The support structure is shown in FIG. 2 is in the form of low pitch coiled spring 42. The alternative structure shown in FIG. 3 is in the form of a series of hoops 44.

The support structure 42, 44 can be conveniently provided with a relatively small diameter, for example, less than 100 mm. It will be appreciated by persons skilled in the art that larger dimensions could be employed.

While the support structures 42, 44 are shown as being separate from the sheath 30, it is anticipated that the support structures 42, 44 could in fact be integrally formed with the sheath 30 in accordance with prior art techniques, for example, techniques for making reinforced hoses with integral metal helix reinforcement and the like .

The second portion 33 of sheath 30 is radially supported by a portion of an enclosed fixed volume fluid filled flexible or distortable cavity or chamber 46 that reacts against the radial stress in sheath 30 when it is extended axially. The fluid filled chamber 46 having a first portion 47 in fluid communication with a second portion 48 and having a constant volume under load within the operating range of the stretch however chamber 46 is otherwise is free to distort in shape in reaction to axial load on sheath 30 and the consequent radial stress on the fluid filled chamber 46. The fluid may be an oil or gel or some other suitable fluid.

Second portion 48 of chamber 46 is housed within second portion 33 of sheath 30 and chamber 46 extends into the first portion 31 of sheath 30 where first portion 47 of chamber 46 is housed and preferably chamber 46 is at least in part defined by sheath 30, and in cooperation with connector housing 32 and insert 34 at either end of sheath 30 collectively define chamber 46.

Advantageously this section construction can facilitate a lower axial stiffness with a relatively high loss tangent when compared to at least some if not all prior art section types of the same size due to hose material choice and the cross ply construction.

Advantageously it is not necessary for the support structure 42, 44 to absorb any axial load for the vibration isolation section 20 to operate.

The support structures 42, 44 advantageously permits a flexibility which would allow the vibration isolation section to be reeled onto a conventional seismic drum during streamer deployment and retrieval.

It will be appreciated that other forms of solid support structures, such as a hollow cylindrical structure, could be employed as alternative to support structures 42, 44 to exhibit the necessary constancy of diameter and reaction to radial stress in the first portion 31 of the sheath 30. However, such structures would lose the flexibility advantage for reeling the section onto a drum and would require the section to be connected during streamer deployment.

The support structure 42, 44 in cooperation with chamber 46 allows a mass of fluid to move as required between the first portion 47 of chamber 46 and second portion 48 and visa versa in reaction to axial load and noise, and in such fluid movement viscous friction arises removing energy from the moving fluid by way of frictional losses.

When sheath 30 is stretched under axial load the volume of the first portion 47 of chamber 46 increases as the length of the first portion 31 of sheath 30 increases and its diameter remains substantially unchanged due to the substantially constant diameter first support structure 42, 44, and the volume of the second portion 48 of chamber 46 cooperatively reduces as mass of fluid flows in reaction to the change of volumes.

Consequently the selective selection of the viscosity of fluid in chamber 46 advantageously provides a mechanism to tune the attenuation of noise for any section 20 by providing some control over the frictional losses for any given axial load.

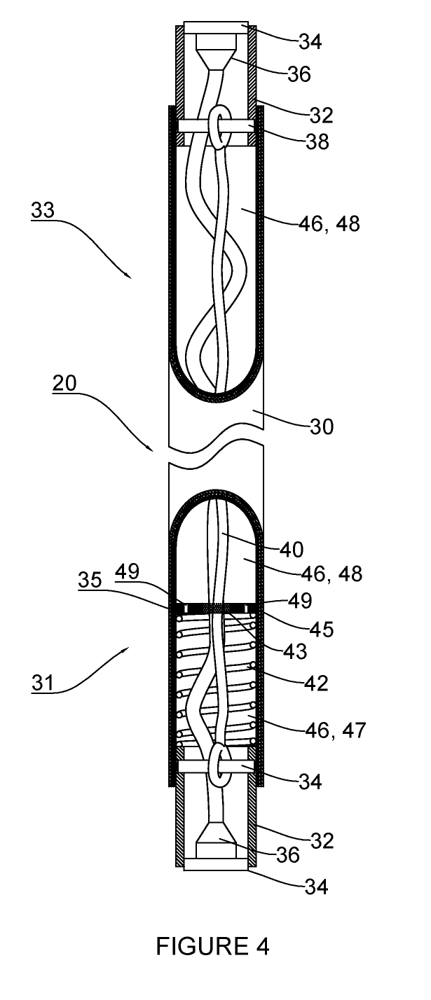

The embodiment in FIG. 4 is similar to the embodiment in FIG. 2 except in the embodiment in FIG. 4 chamber 46 is partitioned by a cylindrical orifice member 45 having at least one opening 49 so that first portion 47 of chamber 46 is in communication with second portion 48 of chamber 46. Snubber rope 40 and electrical/optical harness 36 are passed through a service opening 43 in orifice member 45 that is then sealed off by a suitable material such as resin. Orifice member 45 is fixed or otherwise anchored by a suitable means to the inner portion 35 of sheath 30 adjacent to the end of the first support structure 42 that is closest to the second portion 48 of chamber 46.

Orifice member 45 provides a means to restrict the flow of fluid between the first portion 47 of chamber 46 and second portion 48 and visa versa in reaction to radial stress arising from axial load and noise. An increased restriction of fluid flow through an orifice will increase the frictional losses arising from the flow through the restriction for any given viscosity of fluid.

Consequently the selective selection of the size of the at least one opening 49 in orifice member 45 in cooperation with the viscosity of fluid in chamber 46 advantageously provides a dampening control type mechanism to tune the attenuation of noise for any given section 20.

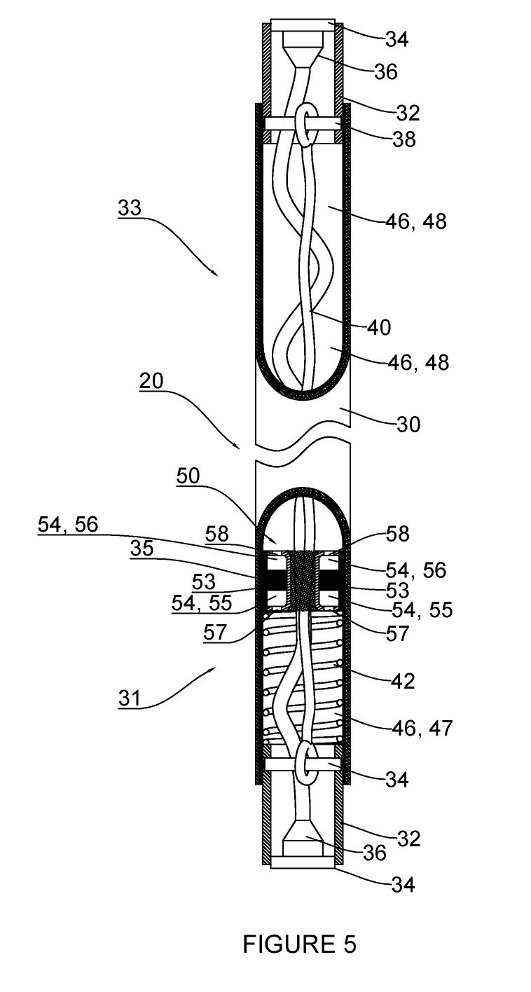

The embodiment in FIG. 5 is similar to the embodiment in FIG. 2 except in the embodiment in FIG. 5 chamber 46 is partitioned by cylindrical mass member assembly 50 that substantially prevents the first portion 47 of chamber 46 being in fluid communication with second portion 48 of chamber 46. Snubber rope 40 and electrical/optical harness 36 are passed through a service opening 52 in mass member assembly 50 that is then sealed off by a suitable material such as resin.

Mass member assembly 50 includes a stationary cylindrical housing member 51 fixed or otherwise anchored by a suitable means to the inner portion 35 of sheath 30 adjacent to the end of the first support structure 42 that is closest to the second portion 48 of chamber 46.

Housing member 51 includes a cylindrically shaped chamber 54 that contains a cooperatively shaped mass member 53 that is free to slide within chamber 54 along the longitudinal axis of section 20. Chamber 54 is in communication with chamber 46 by orifice 57 and orifice 58 and is cooperatively partitioned by mass member 53 into a first portion 55 and a second portion 56, so that mass member 53 substantially prevents the first portion 55 of chamber 54 being in fluid communication with second portion 56 of chamber 54.

Mass member 53 is effectively a sliding partition between the first portion 47 of chamber 46 and the second portion 48 of chamber 46 allowing the volumes of each portion 47, 48 to cooperatively change under axial load.

Mass member assembly 50 provides a means to introduce a discrete moveable mass member 53 in reaction to axial load. When sheath 30 is stretched under axial load the volume of the first portion 47 of chamber 46 increases as the length of the first portion 31 of sheath 30 increases and its diameter remains substantially unchanged due to the substantially constant diameter first support structure 42, 44, and the volume of the first portion 55 of chamber 54 cooperatively reduces as fluid flows in reaction to the change of chamber volumes, similarly the volume of the second portion 48 of chamber 46 cooperatively reduces and the volume of the second portion 56 of chamber 54 cooperatively increases as fluid flows in reaction to the change of chamber volumes, and these fluid flows move mass member 53 within chamber 54 in reaction to the change of chamber volumes giving rise to frictional losses.

The moveable mass member 53 in the flexible fluid filled chamber 46 within the resilient sheath 30 acts like a spring mass system or dynamic absorber system and frictional losses occur when the solid mass member 53 moves in reaction to the moving fluid giving rise to a dynamic absorber effect and contributing to further attenuation of noise in the section 20 most prominently at the resonant frequency of the spring mass system or dynamic absorber system.

By changing the mass of member 53 this will change the resonant frequency at which the dynamic absorber effect is most prominent, and consequently increasing the attenuation of noise in the section 20 at that frequency.

Consequently the selective selection of the mass of moveable member 53 in cooperation with the viscosity of fluid in chamber 46 advantageously provides a dynamic absorber type mechanism to tune the attenuation of noise for any given section 20.

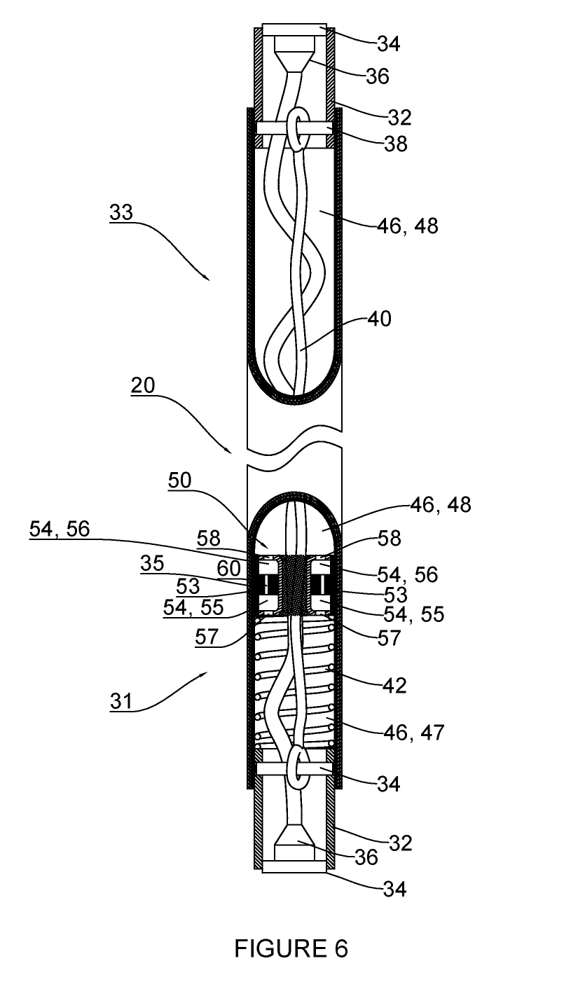

The embodiment in FIG. 6 is similar to the embodiment in FIG. 5 except mass member 53 is provided with at least one orifice 60 that allows communication of fluid between the first 55 and second portion 56 of chamber 54. Consequently the selective opening size in the at least one orifice 60 in cooperation with the viscosity of fluid in chamber 46 advantageously provides a dampening control type mechanism in addition to the dynamic absorber type mechanism arising from the moveable mass 53 to tune the attenuation of noise for any given section 20.

The invention provides section 20 structures that have a lower overall stiffness and lower impedance than most if not all prior art stretch sections of the same size and this communicates to better noise attenuation for any given length of section when compared to the most if not all prior art stretch sections of the same size.

Additionally the invention provides section 20 structures that have stiffness mismatches and density mismatches within the section 20 that introduce impedance mismatches within the section 20 that would not otherwise exist in uniform prior art section structures. These additional impedance mismatches contribute to attenuation of noise and improve the attenuation of noise for any given length of section when compared to sections that do not have these additional impedance mismatches within the section.

Additionally the invention provides section 20 structures that advantageously cause the movement of a mass of fluid when subject to axial load giving rise to frictional losses that attenuate noise. Viscous fluids and the corresponding frictional losses provide an opportunity to advantageously tune to some extent the noise attenuation achievable within any given sized section 20 by the use of fluids of selective viscosity.

Similarly the embodiment of the invention illustrated in FIG. 3 provides an opportunity to advantageously tune to some extent the noise attenuation achievable within any given sized section 20 by the use of fluids of selective viscosity in cooperation with the use of selectively sized opening 49 in an orifice member 45.

Additionally the embodiments of the invention illustrated in FIGS. 5 and 6 provide an opportunity to advantageously tune to some extent the resonant frequency of section 20 at which noise attenuation is maximised by the use of a moveable discrete member 53 of selected mass that moves in reaction to the movement of fluid when subject to axial load as movement of member 53 of selected mass communicates to frictional losses.

Furthermore the embodiment of the invention in FIG. 6 provides for any given sized section 20 an opportunity to tune to some extent the noise attenuation achievable within the section 20 by the cooperative selection of viscosity of the fluid, the mass of moveable discrete member 53, and the size of the opening 60 in member 53, as all of these selections can cooperatively vary the frictional losses that arise in section 20.

The invention has been described by way of example only with reference to preferred embodiments which is not intended to introduce limitations on the scope of the invention. It will be appreciated by persons skilled in the art that alternative embodiments exist even though they may not have been described herein which remain within the scope and spirit of the invention as broadly described herein.

1. A vibration isolation section for use in a seismic streamer system, the section including:
a resilient sheath arranged to be connected end-to-end in a seismic streamer system and receive axial loads transmitted through the system, wherein the resilient sheath is configured to stretch upon receiving an axial load and substantially convert the axial load into a radial stress; and
a first support structure for the resilient sheath and housed within a first portion of the resilient sheath and arranged to resist at least substantial radial contraction of the first portion of the sheath when the sheath is stretched, the support structure including one or more members having substantially constant diameter under load which provides a reaction to the radial stress, thereby reacting to the received axial load; and
a second support structure housed at least in part within a second portion of the resilient sheath, the second support structure including an enclosed fixed volume fluid filled flexible chamber at least partially housed within the second portion of the resilient sheath, the fluid filled flexible chamber providing a reaction to the radial stress thereby reacting to the received axial load.

2. The vibration isolation section according to claim 1, wherein the resilient sheath is an elastic sheath.

3. The vibration isolation section according to claim 1, wherein the first support structure has a coiled-spring structure of substantially constant diameter.

4. The vibration isolation section according to claim 1, wherein the first support structure includes a plurality of spaced apart hoop-shaped members arranged along at least a portion of the length of the elastic sheath.

5. The vibration isolation section according to claim 1, wherein the sheath has a structure including one or more layers of helically wrapped fibres.

6. The vibration isolation section according to claim 5, wherein the one or more layers are embedded in a resilient material.

7. The vibration isolation section according to claim 6, wherein the resilient material is a natural or a synthetic rubber material, or a polyurethane material.

8. The vibration isolation section according to claim 5, wherein the fibres in the first portion of the sheath are predominantly wrapped at an angle between 52° and 90° relative to a central axis of the sheath.

9. The vibration isolation section according to claim 5, wherein the fibres in the second portion of the sheath are predominantly wrapped at an angle of no more than 52° relative to a central axis of the sheath.

10. The vibration isolation section according to claim 1, wherein the first support structure is integrally formed with the sheath.

11. The vibration isolation section according to claim 1, wherein the sheath at least in part defines the chamber.

12. The vibration isolation section according to claim 1, wherein a first portion of the chamber is housed within the first portion of the resilient sheath and a second portion of the chamber is housed within the second portion of the resilient sheath.

13. The vibration isolation section according to claim 12, wherein on receiving an axial load the volume of the first portion of the chamber cooperatively increases as the volume of the second portion of the chamber decreases as a volume of fluid moves between the second and first portions of the chamber.

14. The vibration isolation section according to claim 12, wherein the first portion of the chamber is in communication with the second portion of the chamber by at least one partitioning orifice.

15. The vibration isolation section according to claim 1, wherein the chamber includes a solid mass that is free to move at least partially within the chamber in reaction to the moving fluid.

16. The vibration isolation section according to claim 1, further including a snubber member for limiting the length that the sheath can be stretched.

17. The vibration isolation section according to claim 16, wherein the snubber member is a rope.

18. The vibration isolation section according to claim 1, wherein the fluid is a gel.

19. A seismic streamer system incorporating one or more vibration isolation section according to claim 1.
